(19) United States
(12) Patent Application Publication
(10) Pub. No.: US 2002/0160095 A1
(43) Pub. Date: Oct. 31, 2002

(54) Method for providing an edible scorpion

(76) Inventor: Douglas French, Oaxaca (MX)

Correspondence Address: KENNETH J HOVET LAW OFFICES, 4476 MARKET ST, SUITE 601, VENTURA, CA, 93003, US

(21) Appl. No.: 10/132,924

(22) Filed: Apr. 26, 2002

Related U.S. Application Data
(60) Provisional application No. 60/286,535, filed on Apr. 27, 2001.

(51) Int. Cl. C12G 1/00

(52) U.S. Cl. 426/592

(57) ABSTRACT

A method for providing an edible scorpion in accordance with the present invention includes the steps of catching the scorpion and submerging the scorpion in a vat containing an alcoholic solution for a predetermined amount of the time. Next, the scorpion internal organs and last ball of the scorpion tail (which contains the venom reservoir and stinger) are removed. This leaves the scorpion exoshell. The scorpion exoshell is then boiled in an alcoholic beverage for a predetermined time, rinsed in an alcohol bath and then allowed to cool to room temperature. The scorpion exoshell is placed in a bottle and rinsed by filling the bottle, again with the alcoholic beverage. If the alcoholic beverage remains clear and free and grime and/or discoloration, the process is complete. If not, the scorpion exoshell is removed, placed in another bottle and the rinse step is repeated until the alcoholic beverage remains clear. The result is a stable, edible scorpion, which can be bottled with the alcoholic beverage for further packaging and distribution.

This application claims priority from Provisional Application Serial No. 60/286,535, which was filed Apr. 27, 2001.

### FIELD OF THE INVENTION

The present invention pertains generally to methods for processing animals. More specifically, the present invention pertains to methods for preserving a scorpion in an edible state.

### BACKGROUND OF THE INVENTION

Scorpions are well known as a potential source of danger to humans, and humans usually give scorpions a wide berth in the wild. This is because scorpions have the capability of delivering a poisonous and potentially fatal sting to humans.

In some cases, however, it may be desirable to catch a scorpion and then preserve the scorpion in an edible state for future consumption. For example, it is well known that certain tequilas are marketed by using a worm contained in the bottle of tequila. In similar fashion, an edible scorpion can be an effective marketing technique for certain products, such as alcoholic beverages and other foods. To utilize the edible scorpion in the same way as a worm is provided in certain brands of tequila, then, it is desirable to place the scorpion within a liquid during the packaging process. Once the liquid is consumed, the scorpion is then swallowed, which provides a source of enjoyment to the user.

Preserving an edible scorpion in this manner, however, has inherent disadvantages. Specifically, the scorpion is poisonous and one cannot merely consume an unprocessed scorpion. Additionally, unlike the worm in a bottle of tequila, the scorpion has an exoshell, which easily disintegrates when submerged within a liquid. What is desired is a method for preserving the scorpion so that it lasts for a long time when submerged within an alcoholic beverage.

U.S. Pat. No. 5,968,497, which issued to Jimenez Collado et al. for an invention entitled “Compositions Containing Dialkyl (C1-C6)-Ketone Peroxide For The Preservation of Animal And Human Dead Tissues”, discusses the preservation of human and animal dead tissues. Jimenez Collado et al., however, teach preserving tissue through the use of a composition containing ketone peroxide for preserving tissue in an embalmed state. Similarly, U.S. Pat. No. 5,998,483, which issued to Camiener for an invention entitled “Glyoxal-Containing Preservative Compositions”, discusses preparation of tissues in a pathology-stable form keyed to the use of an aqueous solution of a dialdehyde solution. Neither of these references discusses a system or method for preserving an animal, in particular a scorpion, in a manner that would leave the scorpion in an edible state.

In light of the above, it is an object of the present invention to provide a method and system for providing an edible scorpion which allows for safe consumption of the scorpion. It is another object of the present invention to provide a method and system for providing an edible scorpion which can be submerged within an alcoholic beverage for an extended period of time without disintegrating or losing its shape. Yet another object of the present invention is to provide a method and system for providing an edible scorpion which can be used as a marketing tool for food products. It is another object of the present invention to provide a method and system for providing an edible scorpion which is easy to use in a cost-efficient manner.

### SUMMARY OF THE INVENTION

A method for preparing an edible scorpion includes the steps of providing the scorpion, either by catching the scorpion in the wild or raising the scorpion in captivity, and submerging the scorpion in a vat or suitable container filed with an alcohol solution. This kills the scorpion, yet preserves the scorpion while chemically neutralizing, or “burning” the scorpion venom. Preferably, the scorpion is submerged for at least ten days, and the alcohol solution is preferably at least forty percent (40%) by volume.

After removal from the vat, the methods of the present invention include removing the scorpion internals. To do this, the scorpion is cut on the side of its belly and the internal organs therein are removed. The stinger and the last ball of the tail (which contains the venom reservoir) are further removed. After removal, what remains is essentially the scorpion outer shell, or exoshell.

Subsequent to removal of the scorpion internals, the method of the present invention includes the step of curing the scorpion exoshell. To do this, the scorpion is boiled for a predetermined amount of time in the same type of alcohol it is to be packaged in. After boiling, the scorpion is placed in a bottle, or other suitable container, and repeatedly rinsed by filling the bottle with the alcoholic beverage the bottle is to be packaged with. As the alcoholic beverage fills the bottle, the beverage is observed. If the beverage remains free of any grime and/or discoloration, the scorpion is completely processed and set aside for further bottling, marketing, distribution and consumption. If grime and/or discoloration are present, the scorpion is removed and placed in another bottle and the rinse step is repeated by filling the bottle with the intended alcoholic beverage. The rinsing step is repeated, until the alcoholic beverage within the bottle remains clear.

The result is an intact looking scorpion exoshell that is harmless to a person who is consuming the alcoholic beverage, should that person decide to eat it or swallow it along with the alcoholic beverage.

### BRIEF DESCRIPTION OF THE DRAWINGS

The following invention will be best understood from the drawings, in which similarly referenced characters refer to similarly referenced parts, and in which:

FIG. 1 is a block diagram illustrating the steps for the method of the present invention; and,

FIG. 2 is an isometric view of a container containing an alcoholic beverage and a scorpion processed in accordance with the method illustrated in FIG. 1.

### WRITTEN DESCRIPTION OF THE PREFERRED EMBODIMENTS

Referring now to the Figures, a block diagram illustrating the method for providing an edible scorpion is shown and generally designated by reference character 10. As shown by the block diagram, the initial step in block 12 includes providing a live scorpion. This step can be accomplished either by catching the scorpion in the wild or by raising the scorpion in captivity.

In accordance with known biological principles, the scorpion molts, or sheds its outer exoshell, in a cyclical manner, and the method of the present invention must be accomplished while the scorpion is between molting cycles. Accordingly, it may actually be preferable to provide a scorpion that has been raised in captivity, as it would be possible to observe the scorpion and determine its molting cycle. In any case, the provided scorpion is transported to a facility for further processing.

As denoted by block 13, the next step in the method is to submerge the live scorpion in a vat (not shown) or similar container containing an alcohol solution. The alcohol solution is preferably at least forty percent (40%) alcohol by volume. The scorpion is left submerged in the vat for a time sufficient to chemically neutralize the venom in the scorpion, while at the same time allowing the alcohol solution to soak into the exoshell to preserve the exoshell. Preferably, the scorpion is submerged in the vats for at least three to ten days.

Once the scorpion has soaked sufficiently for the alcohol to neutralize the scorpion venom, the scorpion is removed and the scorpion internals are removed as shown by block 14. To do this, the scorpion is cut on the side of its belly to allow for removal of the scorpion internals. Further, as an added measure of safety, the last ball of the scorpion tail (which contains the venom reservoir) and the scorpion stinger are removed. The remaining portion of the scorpion is essentially the outer shell, or exoshell.

After the scorpion internals, venom reservoir and stinger are removed, the next step in the process, illustrated by block 16, is to cure the scorpion. To do this, the scorpion is boiled in a container containing mezcal tequila (or any other alcoholic beverage the scorpion will be bottled in) for a predetermined period of time, preferably about three minutes.

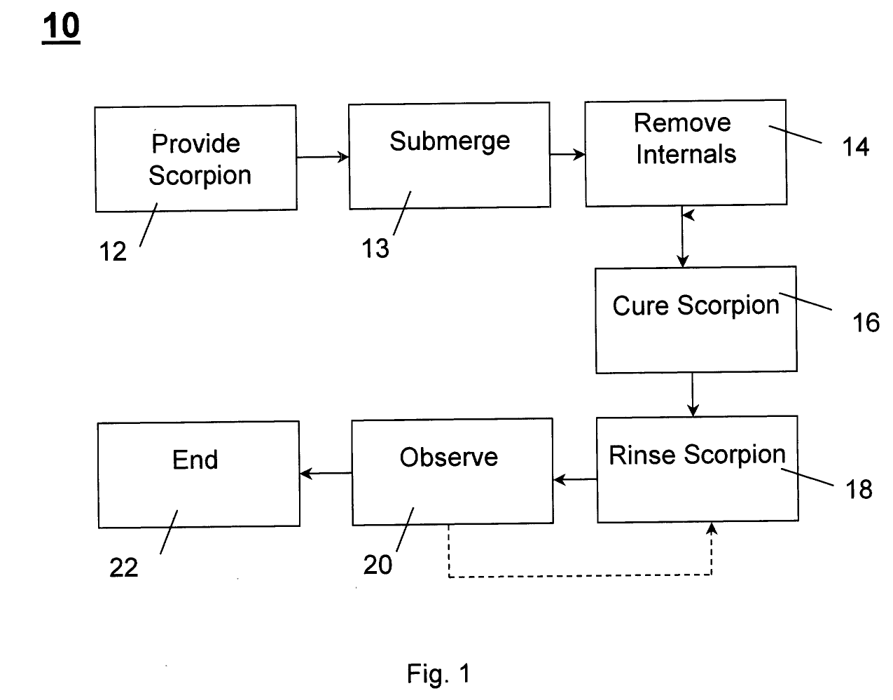

The cured scorpion is then rinsed. To do this, the scorpion is placed in a container (not shown) and the container is filled with the alcoholic beverage the scorpion is to be bottled with. After the container is filled, the alcoholic beverage (which is normally clear) is observed as denoted by block 20. If the beverage remains clear and free of any discoloration and/or grime, the scorpion exoshell is completely processed. If not, and as indicated by the dotted line from block 20 to block 18, the rinsing step is repeated until the alcoholic beverage (and, by extension, the scorpion) is clear and free of any residual grime and impurities. Once the bottle remains clear after rinsing of the scorpion exoshell, the process is ended (See block 22 in FIG. 1). The processed scorpion exoshell is now stable, and can be stored for an extended time in the alcoholic beverage. To do this, a plurality of processed scorpion exoshells are placed in a container which has been filled with the alcoholic beverage for further packaging and distribution at the convenience by the distributor.

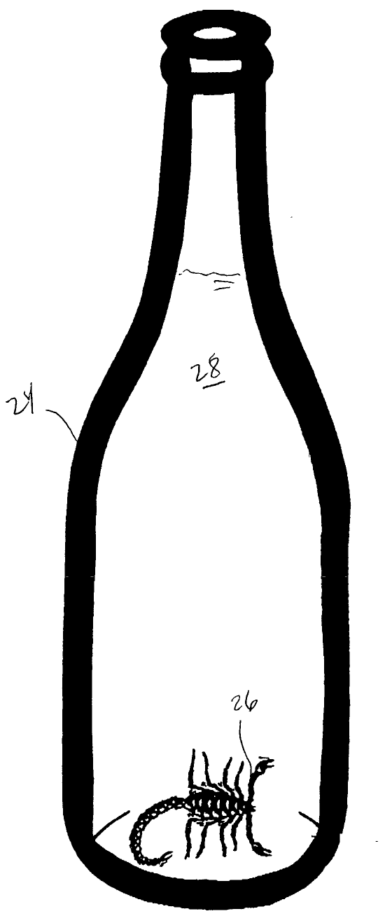

For distribution, and as indicated by FIG. 2, the processed scorpion exoshell 24 is placed in a bottle 26 and bottled with the alcoholic beverage 28 the scorpion was rinsed with. Preferably, the alcoholic beverage for processing the scorpion is at least thirty percent (30%) alcohol by volume, to prevent any further growth of bacteria or other organic matter after bottling of the scorpion.

The result is an intact looking scorpion exoshell that will remain intact for an extended period of time in an alcoholic beverage and further is harmless to a user that might choose to eat it or swallow it in a show of mirthful sport while consuming the alcoholic beverage.

As mentioned above, although the above process was disclosed using mezcal as the agent for the curing and rinsing steps, it is to be appreciated that any alcoholic beverage could be used, provided the beverage is at least thirty percent (30%) alcohol by volume. Further and as briefly mentioned above, the overall process must be accomplished while the scorpion is between molting cycles, to ensure that a stable scorpion exoshell is separated from the scorpion internals during processing of the scorpion.

While the methods and system of the present invention are indicative of the preferred embodiments, it is to be appreciated that they are merely illustrative of the invention, and are not intended to be limiting. Accordingly, no limitations are envisioned by the present invention other than those cited in the appended claims.

What is claimed is:

1. A method for providing an edible scorpion comprising the steps of:
A) obtaining a scorpion;
B) submerging said scorpion in an alcohol solution for a predetermined time;
C) removing the internal organs of said scorpion;
D) curing said scorpion.

2. The method of claim 1 wherein said step B) is accomplished when said scorpion is not molting.

3. The method of claim 1 wherein said alcohol solution is at least forty percent alcohol (40%) by volume.

4. The method of claim 1 wherein said predetermined time in step B) is at least three days.

5. The method of claim 1 wherein step C) includes removing the venom reservoir of said scorpion.

6. The method of claim 1 further comprising the step of:
E) rinsing the scorpion with an alcoholic beverage.

7. The method of claim 6 wherein step E) further comprises the steps of:
F) placing the scorpion in a container;
G) filling the container with an alcoholic beverage; and,
H) observing said alcoholic beverage for any dirt and/or discoloration.

8. The method of claim 7 wherein dirt and/or discoloration is observed during said step H) and further wherein said steps F) through H) are repeated.

9. The method of claim 8 wherein steps F) through H) are repeated until the alcoholic beverage remains clear during step H).

10. The method of claim 6 where step E) is accomplished with an alcoholic beverage that is at least thirty percent (30%) by volume.

11. An edible scorpion system comprising:
a container filled with an alcoholic beverage;
a scorpion submerged in said alcoholic beverage;
said scorpion having been submerged in a vat containing an alcohol solution for a predetermined time prior to being submerged;
said scorpion further having its internal organs, venom reservoir and stinger removed; and,
said scorpion having been cured in said alcoholic beverage for a predetermined duration.

12. The system of claim 11 wherein said alcoholic solution is at least forty percent (40%) alcohol by volume.

13. The system of claim 11 wherein said predetermined time is at least three (3) days.

14. The system of claim 11 wherein said alcoholic beverage is at least thirty percent (30%) alcohol by volume.

15. A method comprising processing a scorpion so as to provide an edible scorpion exoshell; and,
providing said scorpion exoshell in a bottle filled with an alcoholic beverage.
